(19) United States
(12) Patent Application Publication
(10) Pub. No.: US 2014/0207928 A1
(43) Pub. Date: Jul. 24, 2014

(54) Providing Different Levels of Service Over a Storage Transport

(71) Applicant: INTEL CORPORATION, Santa Clara, CA (US)

(72) Inventors: Michael P. Mesnier, Scappoose, OR (US); Radia Perlman, Redmond, WA (US)

(21) Appl. No.: 13/993,374

(22) PCT Filed: Dec. 29, 2011
(86) PCT No.: PCT/US11/67808

§ 371 Date: Jun. 12, 2013

(51) Int. Cl. H04L 12/24

(52) U.S. Cl. CPC H04L 41/507
USPC 709/223

(57) ABSTRACT

In accordance with some embodiments, identification of transport streams facilitates the classification of those streams. Classification of those streams in turn enables a classification to be matched to a quality of service policy. Thus, quality of service policies may be enforced so that different streams can be afforded appropriate quality of service.

### BACKGROUND

This relates generally to storage area networks.

Storage area networks (“SANs”) implement a storage protocol that is responsible for transferring data between a host computer system and a target storage system; it is the protocol that defines how the computer system communicates with the storage system. Storage protocols include the Small Computer Systems Interface (“SCSI”), Advanced Technology Attachment (“ATA”), and Serial ATA (SATA). SCSI is most commonly used when building SANs.

Storage protocols define a block command set (e.g., READ and WRITE) for issuing input/output requests, and they implement a storage transport that is responsible for delivering the commands, the data, and the status between the computer system and the storage system. SCSI, for example, defines a number of different storage transports, including Serial Attached SCSI (SAS), the Fibre Channel Protocol (SAS), and Internet SCSI (iSCSI). A storage controller is a piece of hardware that implements the storage protocol, which includes a storage transports. There is one controller on the host computer system and one on the target storage system.

The storage controllers are connected to a storage fabric (e.g., iSCSI uses an Ethernet fabric) and that storage fabric may have offer quality of service (QoS). It is the responsibility of the storage transport to utilize the services of the fabric (e.g., assigning QoS levels), in order to respect the QoS of each input/output request.

### BRIEF DESCRIPTION OF THE DRAWINGS

FIG. 1 is a system depiction for one embodiment of the present invention; and

FIG. 2 is a flowchart for one embodiment of the present invention.

### DETAILED DESCRIPTION

In accordance with some embodiments, identification of input/output requests facilitates the classification of those input/output requests. A classification of a request may be matched to a quality of service policy. Thus, quality of service policies may be enforced so that different requests can be afforded appropriate quality of service.

In many embodiments, an identifier can be included within an unused group number field in SCSI command sets and a policy can be specified for each identified input/output request depending on its characteristics. However, other command sets, including ATA command sets, may have unused fields that also may be used for identification of input/output requests.

Input/output requests from a host computer system to a transport layer may be classified. Then quality of service policies may be associated with each class. The storage transport can then enforce the quality of service policy on a class by class basis. The storage transport may do so in a way that respects application level quality of service requirements that have already been communicated to a device layer. To this end, in addition to providing a transport layer classification framework, quality of service mechanisms can be used by the transport to enforce a requested quality of service.

A classification component allows a device layer to classify every input/output request sent to a storage transport. A quality of service policy component allows the device layer to associate a quality of service policy with each input/output class. A quality enforcement mechanism component enables a storage transport to enforce quality of service on a class by class basis.

The classification component may use device layer fields, such as SCSI group number and the command descriptor block for disk read and write commands. This device layer field allows an application to classify each input/output request and associate a desired quality of service policy with each class. At the storage transport layer, the field may be inspected and the classifier extracted for each input/output request submitted to the transport.

Classifiers may classify the type of input/output request that is involved. For example, possible classifiers include a log classifier, a small table classifier, an index classifier, and a large table classifier. Each of these classifiers then may be matched within a table stored in a memory with an appropriate quality of service policy. For example, the log classifier may be associated with a fast write, a small table classifier may be associated with a low latency quality of service policy, an index classifier may be also associated with a low latency quality of service policy, and a large table classifier may be associated with a high bandwidth quality of service policy.

The quality of service policies may be specified for each class through a management interface of the storage transport. For example, a class journal may be latency sensitive. The available quality of service policies may be storage transport independent but standard policies may be implemented as well. The policies may be designed to improve performance in some embodiments but security policies may also be applied on a class-by-class basis as well. Thus certain input/output requests may involve over-the-wire encryption performed by the storage transport.

The application layer quality of service may be enforced in the storage transport for each input/output request. Given the application layer quality of service requirements sent down from the device layer, the storage transport may appropriately manage the transfer of commands, data, and status to and from the storage target.

A storage fabric contains multiple paths or service layers that the storage transport can use to provide differentiated service. An example of a storage fabric may be the Ethernet. Thus, generally at least two service layers may be available from the fabric. One service layer may be a low latency path and the other may be a high bandwidth path. In practice, many more service layers may be available.

The storage transport manages these layers to enforce the requested quality of service for a given input/output request. Initially, a control plane is separated from a data plane. The quality of service may be enforced in two ways. The control plane may always use a low latency service of the fabric. The data plane may use the low latency or high bandwidth services depending on the quality of service of the input/output request.

The storage transport may deliver all commands for storage reliably, in order, between a host and a target. In a transport layer, commands may be processed in order where processing a command means the transport layer sends it to the device layer in the target storage system.

Once a device layer receives a command, it may process it out of order. For example, a disk scheduling algorithm may reorder requests. For this reason, commands may be sent down a low latency path in order control plane.

However, the data transfer itself may be out of order and in parallel. Thus, the storage transport is free to send data packets down the low latency or high bandwidth path depending on the quality of service of a given request. Again two service layers are generally needed for processing data though multiple layers may exist in actual practice with different priorities.

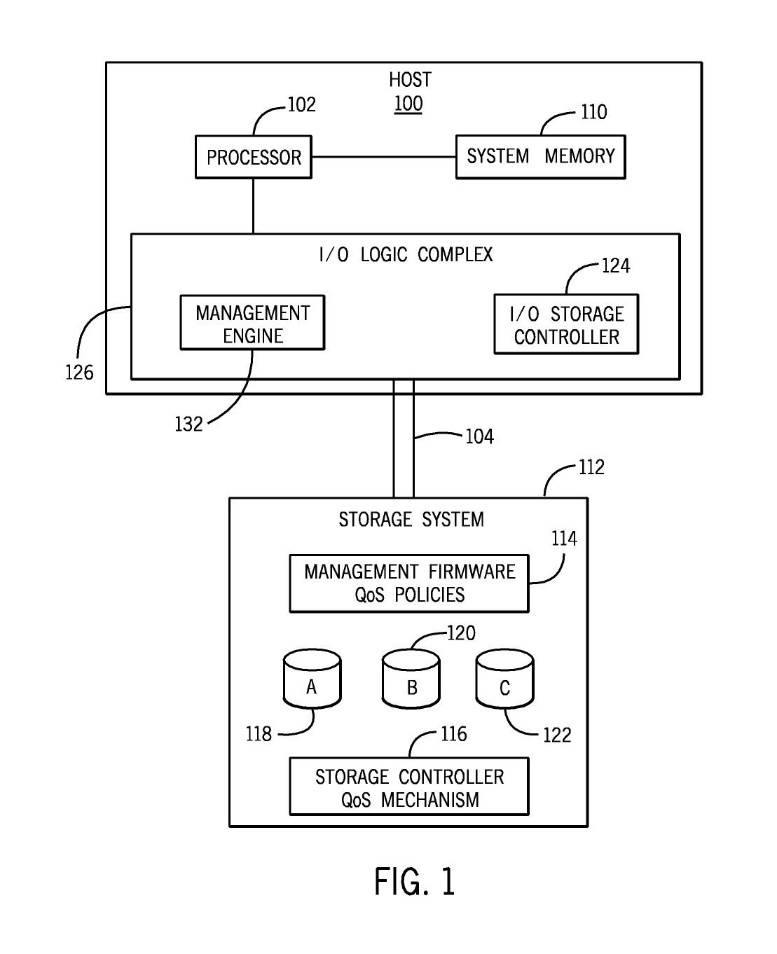

Thus, referring to FIG. 1, the host 100 may include a processor 102 coupled to a system memory 110. The host may be any processor based system including a desktop or laptop computer or mobile device. Input/output logic complex 126 may include a management engine 132 and an input/output storage controller 124. The management engine 132 may be responsible, in one embodiment, for enforcing quality of service in the transport 104 between the host 102 and the storage system 112.

The storage system 112 may include management firmware 114 for implementing quality of service policies. It may include a plurality of different storages that enable different qualities of service including the storage devices 118, 120, and 122 in the example shown in FIG. 1. A storage controller quality of service mechanism 116 may be provided in the storage system as well.

Generally in any storage system, the host operating system uses a file system to provide information about the particular blocks necessary to access a file. Once a file system has provided this block information related to a particular file, the request to access the actual storage medium may be made through a driver in an input/output layer of the host operating system. The input/output layer may include code to process the access request to one or more blocks. In some embodiments, the driver may implement an input/output protocol, such as the SCSI protocol, the Internet SCSI protocol, the serial advanced technology attachment protocol or any other input/output protocol.

The driver may process a block request and send the input/output storage request to a storage controller 124 which then proceeds to access the storage system 112.

Storage media may be located within pools of storage such as the pools 118, 120 and 122. Storage media within the storage pool may include hard disk drives, large non-volatile memory banks, solid state drives, tape drives, optical drives, and/or one or more additional types of storage media in different embodiments.

In many embodiments, a given storage pool may comprise a group of several individual storage devices of a single type. For example, the storage pool 118 may comprise a group of solid state drives, the storage pool 120 may comprise a group of hard disk drives in a redundant array of independent disks (RAID) array, and the storage pool 122 may comprise a group of tape drives. In this example, the storage pool 118 may provide the highest storage quality of service because solid state drives may have better response time than standard hard disk drives or tape drives. Storage pool 120 might provide a medium level of quality of service due to the hard disk drive speed being slower than the solid state drive speed but faster than the tape drive speed. Storage pool 122 may provide a low level of quality of service due to the tape drive speed being the slowest of the three pools. Of course other types of storage media may be provided within one or more storage pools.

A host operating system or application communicates with one or more storage media in the storage pools by having a driver send an input/output storage request to the storage controller 124. The storage controller 124 provides a communication interface with the storage tools over the transport 104. In some embodiments, the storage controller 124 is aware of the level of service or performance of each of the storage pools. Thus, the storage controller 124 may be aware that the storage pool 118 provides a high level of service performance, storage pool 120 provides a medium level of performance, and the storage pool 122 provides a lower level of storage performance.

In some embodiments, the storage pools provide their respective quality of service information to the storage controller 124. In other embodiments, the storage controller actively stores a list that maps a certain quality of service to each storage pool. In yet other embodiments, the storage controller identifies each available storage pool and determines each pool's quality of service level.

The storage controller 124 may include performance monitoring logic that may monitor the performance of transactions to each pool and track a dynamic quality of service matrix for each service pool.

In still other embodiments, an external entity, such as an administrator, may provide input/output storage request routing policies that specify the quality of service levels expected to be provided by each storage pool and which data type should be routed to each pool. Additionally, such an administrator may provide this information throughout an out-of-band communication channel that may be updated through a system management engine 132 located in the host system 100 and coupled to the storage controller 124. The system management engine may be a separate integrated circuit that can assist appropriate entities, such as corporate information technology departments, in performing management tasks related to the computer system.

The storage controller may be integrated into an input/output logic complex 126. The complex 126 may include other integrated controllers for managing portions of the input/output subsystem in the host 100. The complex may be coupled to the host processor 102 through an interconnect in some embodiments. In some embodiments, the storage controller may be discrete or separate from the computer system 100 and the input/output logic complex may communicate with the host processor and system memory 110 through a network.

In some embodiments, input/output tagging logic is implemented in the file system. The input/output tagging logic can specify the type of input/output issued with each input/output storage request. For example, an input/output storage request sent to the storage controller 124 may include file data, directory data or metadata. Each of these types of data may benefit from different levels of service. For example, the metadata may be the most important type of data, the directory data may be the next most important type of data, and the file data may be the least important type of data. These levels of importance are modifiable and may change on implementation. The levels of importance may correspond directly with the quality of service utilized in servicing each type of data. Additionally other types of data may be issued with the input/output storage request.

In any event, embodiments where metadata, directory data, and file data comprise the three types of data to be issued, the file system may include a tag with each block request that specifies the type of data as one of the three or more established types. The block input/output layer, such as a file system layer, of the host operating system may be modified to add an input/output data type tag field to each logical block request to a disk. Then the tag may be passed to a driver in the block input/output layer.

The driver in the input/output layer of the host operating system may then append input/output data type tags along with each input/output storage request sent to the storage controller 124. The specific disk request sent to the storage controller includes the input/output type tag in the field. In some embodiments, the tag may be stored in reserved byte fields in a SCSI or ATA command structure.

The storage controller may include logic to monitor the input/output data type tag field in each input/output data type tag field in each input/output storage request. The storage controller may include logic throughout the input command to a specific storage pool using a specific transport layer based on the level of importance of the type of data issued with the request. Thus, if the data is of high importance, the data may be routed to the highest quality service storage pool request over the highest quality transport layer and if the data is of little importance, the data may be routed to the lowest quality of service storage pool over the lowest quality of service transport layer.

There is only one storage transport, and the data may receive the highest quality of service offered by that storage transport. This can mean routing the request down the highest bandwidth path in the storage fabric.

The storage controller provides a mapping of the logical block address and the input/output storage request to a physical storage device address. Thus, based on the changeable location where the input/output storage request is routed using the input data type tag field, the storage controller provides a dynamic mapping service for input/output storage request.

The storage controller may include a modifiable mapping table that routing logic within the storage controller utilizes to route each incoming input/output storage request from a driver in the host operating system in the input/output layer to a specific storage pool via a specific transport layer with the desired quality of service level. The storage pools are all reached via the same transport. However, that transport may offer different service levels. A particular service level is implemented at the transport level by intelligently using the services of the underlying fabric (e.g., there might be a low-latency path in the fabric, versus a high-bandwidth path). In many embodiments, the quality of service level includes a performance metric that determines that the quality of service is higher based on less storage latency. In other embodiments, the quality of service level includes a security metric that determines that the quality of service is higher based on the relative reliability and/or security needed for the data.

Thus, the input/output logic complex may determine what layer in the transport 104 is used and what storage pool in the storage system 112 is used. It may do this to achieve a specified quality of service in terms of latency, security and/or reliability.

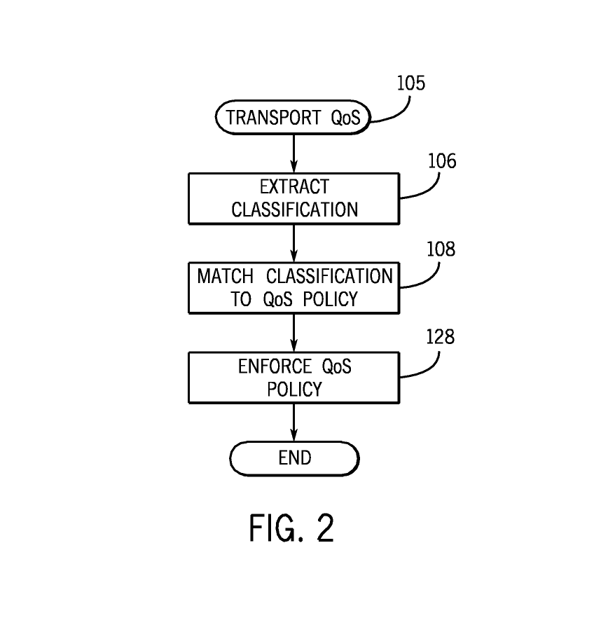

Thus, referring to FIG. 2, a sequence 105 may be implemented in hardware, software, and/or firmware. In software or firmware embodiments it may be implemented by computer executed instructions stored in a non-transitory computer readable medium such as an optical, magnetic, or semiconductor storage. For example, the sequence may be implemented by the input/output logic complex 126 in some embodiments.

Initially, a classification is extracted as indicated in block 106. The classification in some embodiments may be obtained from the device layer field in a command to strip or block for read and write commands.

Then the classification may be matched to a quality of service policy as indicated in block 108. For example, a table may be maintained in the complex 126 that matches classifications to appropriate quality of service polices. Finally, the quality of service policies enforced as indicated in block 128. This may be done by providing the appropriate layer within the transport 104 to transport the data and by providing the appropriate storage pool in the storage system 112.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
identifying, with an identifier, an input/output request from a host computer system to a target storage system;
classifying the request using said identifier;
assigning a quality of service policy to the request based on a request classification; and
transmitting the request from said host computer system to said target storage system using the assigned quality of service policy.

2. The method of claim 1 wherein identifying a request includes using a group number field in a storage transport.

3. The method of claim 1 wherein classifying a request includes using a device layer field in a storage transport.

4. The method of claim 1 wherein classifying a request includes using a field, and extracting data from said field to determine how to service said request.

5. The method of claim 1 including using a table stored in a memory to match a quality of service policy with said identifier.

6. The method of claim 1 including specifying a quality of service policy for the request through a management interface of a storage transport.

7. The method of claim 1 including providing at least two qualities of service including a lower latency path and a higher bandwidth path.

8. The method of claim 7 including using a control plane separated from a data plane such that the control plane always uses the lower latency path and the data plane uses either the lower latency or higher bandwidth path.

9. The method of claim 1 including providing at least two different storages and storing a stream in one or the other said storages based on a quality of service policy.

10. The method of claim 1 including providing at least two storage pools composed of different individual storage devices, each storage pool being associated with a different quality of service policy.

11. A nontransitory computer readable medium storing instructions to enable a processor to:
identify, with an identifier, an input/output request from a host computer system to a target storage system;
classify the request using said identifier;
assign a quality of service policy to the request based on a request classification; and
transmit the request from said host computer system to said target storage system using the assigned quality of service policy.

12. The medium of claim 11 further storing instructions to use a group number field in a storage transport.

13. The medium of claim 11 further storing instructions to use a device layer field in a storage transport.

14. The medium of claim 11 further storing instructions to use a field, and extract data from said field to determine how to service said request.

15. The medium of claim 11 further instructions to use a table stored in a memory to match a quality of service policy with said identifier.

16. The medium of claim 11 further instructions to specify a quality of service policy for the request through a management interface of a storage transport.

17. The medium of claim 11 further instructions to provide at least two qualities of service including a lower latency path and a higher bandwidth path.

18. The medium of claim 17 further instructions to use a control plane separated from a data plane such that the control plane always uses the lower latency path and the data plane uses either the lower latency or higher bandwidth path.

19. The medium of claim 11 further instructions to provide at least two different storages and store a stream in one or the other said storages based on a quality of service policy.

20. The medium of claim 11 further instructions to provide at least two storage pools composed of different individual storage devices, each storage pool being associated with a different quality of service policy.

21. An apparatus comprising:
a controller to identify, with an identifier, an input/output request from a host computer system to a target storage system, classify the request using said identifier, assign a quality of service policy to the request based on a request classification, and transmit the request from said host computer system to said target storage system using the assigned quality of service policy; and
a memory coupled to said controller.

22. The apparatus of claim 21 said controller to use a group number field in a storage transport.

23. The apparatus of claim 21 said controller to store instructions to use a device layer field in a storage transport.

24. The apparatus of claim 21 said controller to to use a field and extract data from said field to determine how to service said request.

25. The apparatus of claim 21 said controller to store in a memory to match a quality of service policy with said identifier.

26. The apparatus of claim 21 said controller to specify a quality of service policy for the request through a management interface of a storage transport.

27. The apparatus of claim 21 said controller to provide at least two qualities of service including a lower latency path and a higher bandwidth path.

28. The apparatus of claim 21 said controller to use a control plane separated from a data plane such that the control plane always uses the lower latency path and the data plane uses either the lower latency or higher bandwidth path.

29. The apparatus of claim 21 said controller to provide at least two different storages and storing a stream in one or the other said storages based on a quality of service policy.

30. The apparatus of claim 21 said controller to provide at least two storage pools composed of different individual storage devices, each storage pool being associated with a different quality of service policy.
